(19) United States
(12) Patent Application Publication
(10) Pub. No.: US 2024/0422135 A1
(43) Pub. Date: Dec. 19, 2024

(54) DATA TRANSMISSION METHOD AND SYSTEM, AND TERMINAL

(71) Applicant: BOE Technology Group Co., Ltd., Beijing (CN)

(72) Inventor: Wei PAN, Beijing (CN)

(21) Appl. No.: 18/705,920

(22) PCT Filed: Apr. 27, 2023
(86) PCT No.: PCT/CN2023/091388

§ 371 Date: Apr. 29, 2024

(30) Foreign Application Priority Data
May 26, 2022 (CN) 202210589026.9

(51) Int. Cl. H04L 9/40; H04W 76/14

(52) U.S. Cl. CPC H04L 63/0428; H04W 76/14

(57) ABSTRACT

The present disclosure provides a data transmission method and system, and a terminal, for use in ensuring the integrity and security of file transmission among different terminals in a smart office scene. The method includes: a first terminal obtains data to be transmitted; the first terminal determines first digest information of the data to be transmitted, wherein the first digest information represents fixed-length encrypted information related to the data to be transmitted; and the first terminal sends to a second terminal the first digest information and the data to be transmitted.

### CROSS-REFERENCE TO RELATED APPLICATION

The present disclosure claims priority to the Chinese Patent Application No. 202210589026.9, filed to the China National Intellectual Property Administration on May 26, 2022, and entitled “Cross-device Data Transmission Method and System, and Terminal”, the entire content of which is incorporated herein by reference.

### TECHNICAL FIELD

The disclosure herein relates to the technical field of smart meetings and data transmission, in particular to a cross-device data transmission method and system, and a terminal.

### BACKGROUND

Meetings are one of the most common forms of work, but with the continuous development of the times, and continuous progress of technology, the traditional meeting mode is no longer applicable to the needs of a modern office, leading to increasingly prominent significance of meeting efficiency and interactive experience in a corporate meeting. Therefore, smart meetings have been proposed, which are an office product integrating various devices including digital whiteboards, computers and remote meeting terminals.

In smart office scenarios, in order to enrich the meeting scenarios, smart meeting terminals can not only realize smart meetings, but also transfer files to each other with user terminals, so as to improve users' experience of attending the meetings. Therefore, how to ensure the security and integrity of the files transmitted between different terminals has become a technical problem that needs to be solved urgently at present.

### SUMMARY

The present disclosure provides a cross-device data transmission method and system, and a terminal, used for ensuring the security and integrity of files transmitted between different terminals in a smart office scenario.

In a first aspect, a cross-device data transmission method provided by an embodiment of the present disclosure includes:
obtaining, by a first terminal, data to be transmitted;
determining, by the first terminal, first digest information of the data to be transmitted, wherein the first digest information represents fixed-length encrypted information related to the data to be transmitted; and
sending, by the first terminal, to a second terminal the first digest information and the data to be transmitted, so that the second terminal verifies validity of received data according to the first digest information.

As an optional implementation, the determining, by the first terminal, first digest information of the data to be transmitted includes:
determining, by the first terminal, the first digest information of the data to be transmitted according to a message digest algorithm.

As an optional implementation, before the sending, by the first terminal, to a second terminal the first digest information and the data to be transmitted, the method further includes:
establishing, by the first terminal, communication connection with the second terminal through a WIFI connection mode.

As an optional implementation, the establishing, by the first terminal, communication connection with the second terminal through a WIFI connection mode includes:
performing, by the first terminal, GO negotiation with the second terminal in response to entering in a WIFI scanning state and scanning the second terminal; and
determining, by the first terminal, to establish the communication connection with the second terminal in response to completion of GO negotiation.

As an optional implementation, the sending, by the first terminal, to a second terminal the first digest information and the data to be transmitted includes:
establishing, by the first terminal, a socket channel with the second terminal based on UDP or TCP; and
sending, by the first terminal, to the second terminal the first digest information and the data to be transmitted through the socket channel.

As an optional implementation, the obtaining, by a first terminal, data to be transmitted includes:
receiving, by the first terminal, a transmission instruction input by a user in a display page, and determining, by the first terminal, the data to be transmitted according to the transmission instruction.

In a second aspect, a cross-device data transmission method provided by an embodiment of the present disclosure includes:
receiving, by a second terminal, first digest information and data sent by a first terminal;
determining, by the second terminal, second digest information of the received data; and
verifying, by the second terminal, validity of the received data according to a comparison result of the first digest information and the second digest information.

As an optional implementation, the determining, by the second terminal, second digest information of the received data includes:
determining, by the second terminal, the second digest information of the received data according to a message digest algorithm.

As an optional implementation, before the receiving, by a second terminal, first digest information and data sent by a first terminal, the method further includes:
establishing, by the second terminal, communication connection with the first terminal through a WIFI connection mode.

As an optional implementation, the establishing, by the second terminal, communication connection with the first terminal through a WIFI connection mode includes:
performing, by the second terminal, GO negotiation with the first terminal in response to entering in a WIFI scanning state and scanning the first terminal; and
determining, by the second terminal, to establish the communication connection with the first terminal in response to completion of GO negotiation.

As an optional implementation, the receiving, by a second terminal, first digest information and data sent by a first terminal includes:
establishing, by the second terminal, a socket channel with the first terminal based on UDP or TCP; and
receiving, by the second terminal, the first digest information and the data through the socket channel.

As an optional implementation, the verifying, by the second terminal, validity of the received data according to a comparison result of the first digest information and the second digest information includes:
determining, by the second terminal, the received data to be valid in response to determining that the first digest information is the same as the second digest information; or
determining, by the second terminal, the received data to be invalid in response to determining that the first digest information is different from the second digest information.

In a third aspect, an embodiment of the present disclosure further provides a cross-device data transmission system, including a first terminal and a second terminal, wherein
the first terminal is configured to obtain data to be transmitted, and determine first digest information of the data to be transmitted, and send to the second terminal the first digest information and the data to be transmitted, wherein the first digest information represents fixed-length encrypted information related to the data to be transmitted; and
the second terminal is configured to receive the first digest information and data sent by the first terminal, determine second digest information of the received data, and verify validity of the received data according to a comparison result of the first digest information and the second digest information.

As an optional implementation, the first terminal determines the first digest information of the data to be transmitted according to a message digest algorithm; and
the second terminal determines the second digest information of the received data according to the message digest algorithm.

As an optional implementation, the first terminal and the second terminal establish communication connection through a WIFI connection mode.

As an optional implementation, verifying, by the second terminal, validity of the received data according to a comparison result of the first digest information and the second digest information includes:
determining, by the second terminal, the received data to be valid in response to determining that the first digest information is the same as the second digest information; or
determining, by the second terminal, the received data to be invalid in response to determining that the first digest information is different from the second digest information.

In a fourth aspect, an embodiment of the present disclosure further provides a terminal, including a processor and a memory, wherein the memory is configured to store a program executable by the processor, and the processor is configured to read the program in the memory and execute the following steps:
obtaining data to be transmitted;
determining first digest information of the data to be transmitted, wherein the first digest information represents fixed-length encrypted information related to the data to be transmitted; and
sending to a second terminal the first digest information and the data to be transmitted, so that the second terminal verifies validity of received data according to the first digest information.

As an optional implementation, the processor is specifically configured to execute:
determining the first digest information of the data to be transmitted according to a message digest algorithm.

As an optional implementation, before the sending to a second terminal the first digest information and the data to be transmitted, the processor is specifically further configured to execute:
establishing communication connection with the second terminal through a WIFI connection mode.

As an optional implementation, the processor is specifically configured to execute:
performing GO negotiation with the second terminal in response to entering in a WIFI scanning state and scanning the second terminal; and
determining to establish the communication connection with the second terminal in response to completion of GO negotiation.

As an optional implementation, the processor is specifically configured to execute:
establishing a socket channel with the second terminal based on UDP or TCP; and
sending to the second terminal the first digest information and the data to be transmitted through the socket channel.

As an optional implementation, the processor is specifically configured to execute:
receiving a transmission instruction input by a user in a display page, and determining the data to be transmitted according to the transmission instruction.

In a fifth aspect, an embodiment of the present disclosure further provides a terminal, including a processor and a memory, wherein the memory is configured to store a program executable by the processor, and the processor is configured to read the program in the memory and execute the following steps:
receiving first digest information and data sent by a first terminal;
determining second digest information of the received data; and
verifying validity of the received data according to a comparison result of the first digest information and the second digest information.

As an optional implementation, the processor is specifically configured to execute:
determining the second digest information of the received data according to a message digest algorithm.

As an optional implementation, before the receiving first digest information and data sent by a first terminal, the processor is specifically further configured to execute:
establishing communication connection with the first terminal through a WIFI connection mode.

As an optional implementation, the processor is specifically configured to execute:
performing GO negotiation with the first terminal in response to entering in a WIFI scanning state and scanning the first terminal; and
determining to establish the communication connection with the first terminal in response to completion of GO negotiation.

As an optional implementation, the processor is specifically configured to execute:
establishing a socket channel with the first terminal based on UDP or TCP; and
receiving the first digest information and the data through the socket channel.

As an optional implementation, the processor is specifically configured to execute:
determining the received data to be valid in response to determining that the first digest information is the same as the second digest information; or
determining the received data to be invalid in response to determining that the first digest information is different from the second digest information.

In a sixth aspect, an embodiment of the present disclosure provides a cross-device data transmission apparatus, including:
an obtaining module, configured to obtain data to be transmitted;
a determining module, configured to determine first digest information of the data to be transmitted, wherein the first digest information represents fixed-length encrypted information related to the data to be transmitted; and
a sending module, configured to send to a second terminal the first digest information and the data to be transmitted, so that the second terminal verifies validity of received data according to the first digest information.

As an optional implementation, the determining module is specifically configured to:
determine the first digest information of the data to be transmitted according to a message digest algorithm.

As an optional implementation, before the sending to a second terminal the first digest information and the data to be transmitted, the apparatus further includes a connecting module configured to:
establish communication connection with the second terminal through a WIFI connection mode.

As an optional implementation, the connecting module is specifically configured to:
perform GO negotiation with the second terminal in response to entering in a WIFI scanning state and scanning the second terminal; and
determine to establish the communication connection with the second terminal in response to completion of GO negotiation.

As an optional implementation, the sending module is specifically configured to:
establish a socket channel with the second terminal based on UDP or TCP; and
send to the second terminal the first digest information and the data to be transmitted through the socket channel.

As an optional implementation, the obtaining module is specifically configured to:
receive a transmission instruction input by a user in a display page, and determine the data to be transmitted according to the transmission instruction.

In a seventh aspect, an embodiment of the present disclosure provides a cross-device data transmission apparatus, including:
a receiving module, configured to receive first digest information and data sent by a first terminal;
a determining module, configured to determine second digest information of the received data; and
a verifying module, configured to verify validity of the received data according to a comparison result of the first digest information and the second digest information.

As an optional implementation, the receiving module is specifically configured to:
determine the second digest information of the received data according to a message digest algorithm.

As an optional implementation, before the receiving first digest information and data sent by a first terminal, the apparatus further includes a connecting module configured to:
establish communication connection with the first terminal through a WIFI connection mode.

As an optional implementation, the connecting module is specifically configured to:
perform GO negotiation with the first terminal in response to entering in a WIFI scanning state and scanning the first terminal; and
determine to establish the communication connection with the first terminal in response to completion of GO negotiation.

As an optional implementation, the receiving module is specifically configured to:
establish a socket channel with the first terminal based on UDP or TCP; and
receive the first digest information and the data through the socket channel.

As an optional implementation, the verifying module is specifically configured to:
determine the received data to be valid in response to determining that the first digest information is the same as the second digest information; or
determine the received data to be invalid in response to determining that the first digest information is different from the second digest information.

In an eight aspect, an embodiment of the present disclosure further provides a non-transient computer storage medium, wherein the storage medium stores a computer-executable instruction, and the computer-executable instruction, when executed by a processor, implements steps of the method in the above first aspect or second aspect.

These or other aspects of the present disclosure will become more concise and more easily understood in the description of the following embodiments.

### BRIEF DESCRIPTION OF FIGURES

In order to more clearly illustrate the technical solutions in the embodiments of the present disclosure, a brief description will be given below on the drawings which need to be used in the description of the embodiments. Apparently, the drawings in the description below are only some embodiments of the present disclosure, and for those of ordinary skill in the art, other drawings may also be obtained according to these drawings without involving any inventive effort.

FIG. 1 is an implementation flow chart of a cross-device data transmission method provided by an embodiment of the present disclosure.

FIG. 2 is a schematic diagram of a prompt interface provided by an embodiment of the present disclosure.

FIG. 3 is a specific implementation flow chart of a cross-device data transmission method provided by an embodiment of the present disclosure.

FIG. 4 is an implementation flow chart of a cross-device data transmission method provided by an embodiment of the present disclosure.

FIG. 5 is a specific implementation flow chart of a cross-device data transmission method provided by an embodiment of the present disclosure.

FIG. 6 is a schematic diagram of a cross-device data transmission system provided by an embodiment of the present disclosure.

FIG. 7 is a flow chart of an interaction process of a first terminal and a second terminal provided by an embodiment of the present disclosure.

FIG. 8 is a schematic diagram of a terminal provided by an embodiment of the present disclosure.

FIG. 9 is a schematic diagram of a terminal provided by an embodiment of the present disclosure.

FIG. 10 is a schematic diagram of a first cross-device data transmission apparatus provided by an embodiment of the present disclosure.

FIG. 11 is a schematic diagram of a second cross-device data transmission apparatus provided by an embodiment of the present disclosure.

### DETAILED DESCRIPTION

In order to make the objectives, technical solutions, and advantages of the present disclosure clearer, the present disclosure will be further described in detail with reference to the accompanying drawings. Apparently, the described embodiments are only a part of the embodiments of the present disclosure, rather than all the embodiments. Based on the embodiments of the present disclosure, all other embodiments obtained by those of ordinary skill in the art without creative effort shall fall within the protection scope of the present disclosure.

The term “and/or” in the embodiments of the present disclosure describes an association relationship of associated objects, which means that there may be three relationships, for example, A and/or B may represent: only A exists, A and B exist at the same time, or only B exists. The character “/” generally indicates that the associated objects before and after the character are in an “or” relationship.

The application scenarios described in the embodiments of the present disclosure are intended to more clearly illustrate the technical solutions of the embodiments of the present disclosure, and do not constitute a limitation on the technical solutions provided in the embodiments of the present disclosure. Those of ordinary skill in the art know that with the emergence of the new application scenarios, the technical solutions provided in the embodiments of the present disclosure are equally applicable to similar technical problems. In the description of the present disclosure, unless otherwise specified, “a plurality of” means two or more than two.

Embodiment 1. Meetings are one of the most common forms of work, but with the continuous development of the times, and continuous progress of technology, the traditional meeting mode is no longer applicable to the needs of a modern office, leading to increasingly prominent significance of meeting efficiency and interactive experience in a corporate meeting. Therefore, smart meetings have been proposed, which are an office product integrating various devices including digital whiteboards, computers and remote meeting terminals. With the popularization of terminal devices, there is an increasing demand for sharing files such as pictures, videos, music, electronic documents, and spreadsheets between devices. In smart office scenarios, in order to enrich the meeting scenarios, smart meeting terminals can not only realize smart meetings, but also transmit files to each other with user terminals, so as to improve users' experience of attending the meetings. Therefore, how to ensure the security and integrity of the files transmitted between different terminals has become a technical problem that needs to be solved urgently at present.

In a smart office scenario, a conference all-in-one machine requires transmission of files among user terminals such as a laptop computer, a tablet computer, or a cellular phone, and generally in such a scenario, the files to be transmitted will not be very large, but there are high requirements for the security of the transmission. The embodiment provides a cross-device data transmission method, the core idea of which is to transmit encrypted information related to data while transmitting the data, so that a receiving terminal verifies the security and integrity of the received data based on the encrypted information.

A cross-device data transmission method provided by an embodiment of the present disclosure is applied to a first terminal. The first terminal in the embodiment includes but is not limited to a user terminal or a smart meeting terminal. The user terminal includes but is not limited to: a mobile phone, a tablet computer, a notebook computer or other portable user terminals. The smart meeting terminal includes a meeting terminal, a conference all-in-one machine, etc.

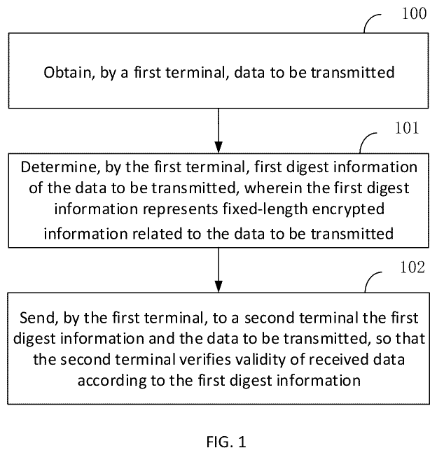

As shown in FIG. 1, a specific implementation flow of the method is as follows.

Step 100, the first terminal obtains data to be transmitted.

In some embodiments, the first terminal obtains the data to be transmitted through the following manner:
the first terminal receives a transmission instruction input by a user in a display page, and determines the data to be transmitted according to the transmission instruction.

Step 101, the first terminal determines first digest information of the data to be transmitted, wherein the first digest information represents fixed-length encrypted information related to the data to be transmitted.

In some embodiments, the first terminal in the embodiment determines the first digest information of the data to be transmitted according to a message digest algorithm. The message digest algorithm is an algorithm that produces a pseudo-random output of a fixed length by kneading and summing inputs of arbitrary length.

In some embodiments, the message digest algorithm in the embodiment includes but is not limited to at least one of a message digest (MD), a secure hash algorithm (SHA), or a message authentication code (MAC).

A calculating process of digest information is illustrated below taking the secure hash algorithm SHA-256 as an example. Calculation of the SHA-256 may be divided into 3 parts.

### (1) Padding of Messages.

Padding of an SHA-256 message follows two principles. The first principle is that, after padding any length of input data (the data to be transmitted), the number of bits of the padded data obtained must be an integer multiple of 512 bits (64 bytes), which may also be interpreted as the data to be transmitted being grouped by 512 bits; and the second principle is that, the last 64 bits (8 bytes) of the padded data represent a length of the input data itself (i.e., the total number of bits occupied by the input data). The data to be transmitted is padded according to the above two principles.

### (2) Generation of Wₜ₋

For the SHA-256 algorithm, a hash operation includes 64 rounds in total. In each round, one 32-digit Wₜ value needs to participate in the calculation, and a total of 64 Wₜ values are needed. A generation formula of the Wₜ value is shown as follows:

$$\begin{matrix}{W}_{t} = M [ ( 32 * t + 31 ) : ( 32 * t ) ] & 0 <= t < 16\end{matrix} ; \qquad formula ( 1 )$$

M represents an array of the data to be transmitted after grouping by 512 digits, and may be presented as M [511:0], wherein W₀-W₁₅ represent the array part. For example, when t=0, W₀=M [31:0], that is, the first 32 digits in the 512 digits; and when t=1, W₁=M [63:32].

$$\begin{matrix}Wt = σ1 ( Wt - 2 ) + Wt - 7 + σ0 ( Wt - 15 ) + Wt - 16 & 16 <= t < 64\end{matrix} ; \qquad formula ( 2 )$$

in the formula (2):

$${σ}_{0} ( x ) = {S}_{7} ( x ) ⊕ {S}_{18} ( x ) ⊕ {R}_{3} ( x ) ;$$

$${σ}_{1} ( x ) = {S}_{17} ( x ) ⊕ {S}_{19} ( x ) ⊕ {R}_{10} ( x ) ;$$

⊕ represents bitwise “xor”; Sₙ represents moving x by n bits to the right; and Rₙ represents moving x by n bits to the right.

### (3) Hash Operation.

Each round of the hash algorithm requires three input parameters: eight 32-bit hash values, a constant Kₜ, a Wₜ value (representing the array of the data to be transmitted after grouping), and an output is eight 32-bit hash values. If the data to be transmitted is subjected to 512-bit grouping to obtain a plurality of 512-bit arrays, the previous calculation of the output of the eight 32-bit hash values is used as the input to the next calculation, until all the arrays are calculated, and finally the eight 32-bit hash values are obtained, which are the ultimate digest information needed.

In implementation, a flow of calculating the first digest information of the data to be transmitted is as follows:
Flow 1, the data to be transmitted is read, the data is grouped by 64 bytes (512 digits), and a plurality of arrays are obtained;
Flow 2, the last array is analyzed, padding is performed according to requirements, and the last 8 bytes are padded as a data length of the data to be transmitted;
Flow 3, 8 hash values and the constant Kₜ are initialized;
Flow 4, 64-byte arrays are loop input, and the hash values are calculated;
for the first time, the first array, the initialized 8 32-digit hash values and the constant Kₜ are input, the 8 hash values output for the first time are obtained through calculation, the 8 hash values output for the first time are used as input for the second time, the second array and the constant Kₜ are input for the second time to obtain the 8 hash values output for the second time through further calculation, the 8 hash values output for the second time are used as input for the third time, and so on until all the arrays are calculated; and
Flow 5, the 8 hash values finally obtained through calculation are used as the first digest information of the data to be transmitted and are output.

Step 102, the first terminal sends to a second terminal the first digest information and the data to be transmitted, so that the second terminal verifies validity of received data according to the first digest information.

In some embodiments, before sending the data, the first terminal may first send the first digest information to the second terminal, and then send the data. After receiving the data, the second terminal uses the same message digest algorithm as used by the first terminal to calculate second digest information of the received data, and compares the first digest information and the second digest information. If the two are the same, the data transmitted is normal and valid, or if the two are different, the data transmitted is incomplete or tampered, and is invalid.

In some embodiments, before sending the first digest information and the data to be transmitted to the second terminal, the first terminal needs to establish a channel for data transmission with the second terminal, so as to perform transmission of data and files through an established socket channel. In implementation, the first terminal and the second terminal establish the socket channel based on a user datagram protocol (UDP) or a transmission control protocol (TCP); and the first terminal sends to the second terminal the first digest information and the data to be transmitted through the socket channel.

The first terminal and the second terminal establish the socket channel based on the UDP or TCP, and a data transmission process is performed through a data frame format as shown in Table 1:

TABLE 1
Data Frame Format

| Function | Data | Packet | Payload | |
|---|---|---|---|---|
| code | format | sequence number | length | Payload |
| 1 byte | 1 byte | 2 bytes | 2 bytes | 0-61440 bytes |

a 1-byte data format represents a hexadecimal system; a 2-byte data format represents an ASCII code; and a packet sequence number represents consecutive integers, and counting starts over from zero in case of overflow.

Definitions of the above function codes are as shown in Table 2:

TABLE 1
Definitions of Function Codes

| Function code value | | Payload |
|---|---|---|
| (hexadecimal) | Description | content |
| 0x01 | Send a data request | Name of data |
| 0x02 | Receive a data response | yes/no |
| 0x03 | Send a data message digest | |
| 0x04 | Receive a data message | |
| | digest response | |
| 0x05 | Send data content | |
| 0x06 | Receive a data content | |
| | response | |
| 0x07 | End of data sending | |
| 0x08 | Receive a response to | ok/error (inconsistency between the |
| | end of data sending | message digests) |
| 0x09 | Interrupted data | |
| | transmission | |
| 0x0A | Interrupted data | |
| | transmission response | |

In some embodiments, when the first terminal fails to receive a response frame from the second terminal, the first terminal may stop sending the data, display a sending failure and send a data frame on interrupted data transmission. When the second terminal receives the data overtime, the second terminal may also send a data frame on interrupted data transmission and stop a data transmission process.

Before the first terminal in the embodiment sends the data and the first digest information, the first terminal needs to first establish communication connection with the second terminal. Normally, the communication connection may be established through Bluetooth or Wi-Fi for data transmission. Because Wi-Fi is wider in bandwidth, compared to Bluetooth, a file may be transmitted at a higher speed by using Wi-Fi. In some embodiments, the embodiment provides a mode for establishing the communication connection as follows:
the first terminal establishes the communication connection with the second terminal through a WIFI connection mode. In implementation, after the first terminal establishes the communication connection with the second terminal through WIFI connection, the first terminal may send the first digest information and the data to be transmitted to the second terminal through a WIFI mode, and exchange of data and messages may be performed through the WIFI mode.

It should be noted that, WIFI connection, also known as WLAN direction connection, is one of Wi-Fi protocol clusters that allows devices to easily connect to each other without a need for an intermediary wireless access point (AP). Its use ranges from web browsing to file transmission and to communication among a plurality of devices at the same time, taking full advantage of Wi-Fi's speed. Devices complying with this standard may be easily interconnected, even if they come from different manufacturers. Compared to Bluetooth, WIFI connection is faster and more suitable for transmitting large files in close proximity.

In some embodiments, a process of the first terminal and the second terminal establishing WIFI connection is shown as follows:
the first terminal performs group owner (GO) negotiation with the second terminal in response to entering in a WIFI scanning state and scanning the second terminal; and
the first terminal determines to establish the communication connection with the second terminal in response to completion of GO negotiation.

In implementation, after the first terminal and the second terminal establish the communication connection, steps for transmitting the file usually include the following steps: step 1, a sending terminal discovers a receiving terminal; step 2, the sending terminal is connected to the receiving terminal; step 3, the sending terminal sends the file to the receiving terminal; and step 4, file sending is completed, and the sending terminal is disconnected from the receiving terminal. The first terminal is the sending terminal and the second terminal is the receiving terminal; or, the first terminal is the receiving terminal and the second terminal is the sending terminal, which is not overly limited in the embodiment.

The first terminal and the second terminal in the embodiment discover each other and establish the connection through WIFI connection. In implementation, a process of discovering and establishing the connection is as follows: the first terminal and the second terminal turn on Wi-Fi, both enter a scanning stage, and send a probe request to search for all devices around; and then the first terminal and the second terminal alternatively enter a listening and a searching stage, and in response to determining that a device sending a probe response exists, the device can be discovered. For example, in response to determining that the second terminal sends the probe response, the second terminal may be discovered by the first terminal, and after the first terminal or the second terminal discovers a device, the discovered device may be shown for a user to choose. When the user chooses a device to be connected, for example, the user chooses on the first terminal to connect to the second terminal, the first terminal and the second terminal start group owner (GO) negotiation. GO negotiation includes three types of frames, that is, a GO request, a GO response and a GO confirmation. Between the two terminals performing GO negotiation, one of the terminals plays a role of a Wi-Fi direct group owner (GO), and the other terminal plays a role of a group client (GC). Optionally, the first terminal is the GO and the second terminal is the GC; or, the first terminal is the GC and the second terminal is the GO, which is not overly limited in the embodiment. After the first terminal and the second terminal perform GO negotiation, the two terminals establish the communication connection.

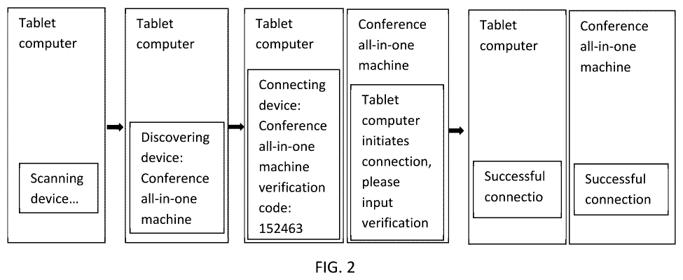

In some embodiments, to facilitate the user's operation, a prompt interface is further displayed on the first terminal or the second terminal. The prompt interface includes reminder information such as discovery of the device, inputting of a verification code, and successful connection. As shown in FIG. 2, the embodiment provides a schematic diagram of establishing WIFI connection, taking connection between a tablet computer (the first terminal) and a conference all-in-one machine (the second terminal) as an example. When the tablet computer turns on the WIFI for a scanning state, and when the conference all-in-one machine is scanned, a name, a logo and other information of the conference all-in-one machine are displayed; the tablet computer requests to establish connection with the conference all-in-one machine, and a verification code “152463” for establishing the connection is displayed; and after the conference all-in-one PC receives the request to establish the connection, an interface of inputting the verification code is displayed, the verification code “152463” for establishing the connection which is displayed on the tablet computer is input, and after the input is completed, the tablet computer and the conference all-in-one PC establish the connection and display the successful connection.

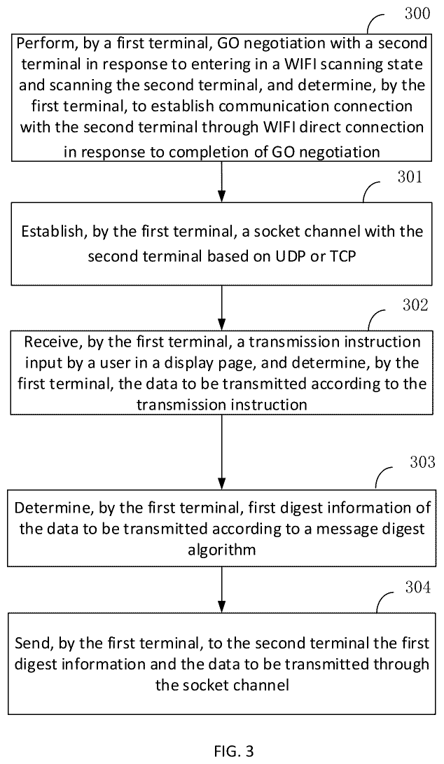

As shown in FIG. 3, the embodiment provides a specific implementation flow of a cross-device data transmission method, shown as follows:
Step 300, the first terminal performs GO negotiation with the second terminal in response to entering in the WIFI scanning state and scanning the second terminal; and the first terminal determines to establish the communication connection with the second terminal through WIFI connection in response to completion of GO negotiation;
Step 301, the first terminal and the second terminal establish a socket channel based on the UDP or TCP;
Step 302, the first terminal receives a transmission instruction input by the user in the display page, and determines the data to be transmitted according to the transmission instruction;
Step 303, the first terminal determines the first digest information of the data to be transmitted according to the message digest algorithm; and
Step 304, the first terminal sends to the second terminal the first digest information and the data to be transmitted through the socket channel.

Based on the same inventive concept, an embodiment further provides a cross-device data transmission method, applied to a second terminal. The second terminal in the embodiment of the present disclosure includes but is not limited to a user terminal or a smart meeting terminal. The user terminal includes but is not limited to: a mobile phone, a tablet computer, a notebook computer or other portable user terminals. The smart meeting terminal includes a meeting terminal, a conference all-in-one machine, etc.

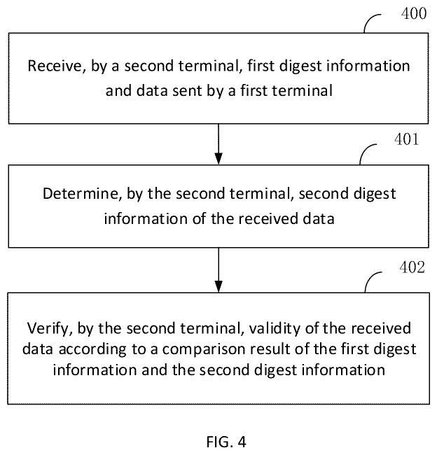

As shown in FIG. 4, a specific implementation flow of the method is as follows:
Step 400, the second terminal receives first digest information and data sent by a first terminal.

In some embodiments, before the second terminal receives the first digest information and the data sent by the first terminal, the second terminal may further establish communication connection with the first terminal through a WIFI connection mode.

It should be noted that, WIFI connection, also known as WLAN direction connection, is one of the Wi-Fi protocol clusters that allows devices to easily connect to each other without a need for an intermediary wireless access point (AP). Its use ranges from web browsing to file transmission and to communication among a plurality of devices at the same time, taking full advantage of Wi-Fi's speed. Devices complying with this standard may be easily interconnected, even if they come from different manufacturers. Compared to Bluetooth, WIFI connection is faster and more suitable for transmitting large files in close proximity.

In some embodiments, the second terminal establishes the communication connection with the first terminal through the following mode:
the second terminal performs group owner (GO) negotiation with the first terminal in response to entering in a WIFI scanning state and scanning the first terminal; and the second terminal determines to establish the communication connection with the first terminal in response to completion of GO negotiation.

In implementation, after the first terminal and the second terminal establish the communication connection through the WIFI connection, the first terminal may send the first digest information and the data to be transmitted to the second terminal through a WIFI mode, and exchange of data and messages may be performed through the WIFI mode.

In implementation, after the first terminal and the second terminal establish the communication connection, steps for transmitting the file usually include the following steps: step 1, a sending terminal discovers a receiving terminal; step 2, the sending terminal is connected to the receiving terminal; step 3, the sending terminal sends the file to the receiving terminal; and step 4, file sending is completed, and the sending terminal is disconnected from the receiving terminal. The first terminal is the sending terminal and the second terminal is the receiving terminal; or, the first terminal is the receiving terminal and the second terminal is the sending terminal, which is not overly limited in the embodiment.

The first terminal and the second terminal in the embodiment discover each other and establish the connection through WIFI connection. In implementation, a process of discovering and establishing the connection is as follows: the first terminal and the second terminal turn on Wi-Fi, both enter a scanning stage, and send a probe request to search for all devices around; and then the first terminal and the second terminal alternatively enter a listening and a searching stage, and in response to determining that a device sending a probe response exists, the device can be discovered. For example, in response to determining that the second terminal sends the probe response, the second terminal may be discovered by the first terminal, and after the first terminal or the second terminal discovers a device, the discovered device may be shown for a user to choose. When the user chooses a device to be connected, for example, the user chooses on the first terminal to connect to the second terminal, the first terminal and the second terminal start group owner (GO) negotiation. GO negotiation includes three types of frames, that is, a GO request, a GO response and a GO confirmation. Between the two terminals performing GO negotiation, one of the terminals plays a role of a Wi-Fi direct group owner (GO), and the other terminal plays a role of a group client (GC). Optionally, the first terminal is the GO and the second terminal is the GC; or, the first terminal is the GC and the second terminal is the GO, which is not overly limited in the embodiment. After the first terminal and the second terminal perform GO negotiation, the two terminals establish the communication connection.

In some embodiments, to facilitate the user's operation, a prompt interface is further displayed on the first terminal or the second terminal. The prompt interface includes reminder information such as discovery of the device, inputting of a verification code, and successful connection.

In some embodiments, after the first terminal and the second terminal establish the communication connection, the second terminal may further establish a socket channel with the first terminal based on UDP or TCP, and receive the first digest information and the data through the socket channel.

In implementation, for the first terminal and the second terminal to establish the socket channel based on the UDP or TCP, a data frame format of data transmission is shown above, and repetitions will not be made here.

In some embodiments, when the first terminal fails to receive a response frame from the second terminal, the first terminal may stop sending the data, display a sending failure and send a data frame on interrupted data transmission. When the second terminal receives the data overtime, the second terminal may also send a data frame on interrupted data transmission and stop a data transmission process.

Step 401, the second terminal determines second digest information of the received data.

In some embodiments, the second terminal determines the second digest information of the received data according to a message digest algorithm. The message digest algorithm is an algorithm that produces a pseudo-random output of a fixed length by kneading and summing inputs of arbitrary length.

In some embodiments, the message digest algorithm in the embodiment includes but is not limited to at least one of a message digest (MD), a secure hash algorithm (SHA), or a message authentication code (MAC). For a detailed SHA calculation process, reference may be made to the above description, and repetitions will not be made here.

It should be noted that the message digest algorithm used to calculate the first digest information and the message digest algorithm used to calculate the second digest information in the embodiment are the same.

To take the secure hash algorithm SHA-256 as an example, a flow of calculating the second digest information of the received data is as follows:
Flow 1, the received data is read, the data is grouped by 64 bytes (512 digits), and a plurality of arrays are obtained;
Flow 2, the last array is analyzed, padding is performed according to requirements, and the last 8 bytes are padded as a data length of the received data;
Flow 3, 8 hash values and the constant Kₜ are initialized;
Flow 4, 64-byte arrays are loop input, and the hash values are calculated;
for the first time, the first array, the initialized 8 32-digit hash values and the constant Kₜ are input, the 8 hash values output for the first time are obtained through calculation, the 8 hash values output for the first time are used as input for the second time, the second array and the constant Kₜ are input for the second time to obtain the 8 hash values output for the second time through further calculation, the 8 hash values output for the second time are used as input for the third time, and so on until all the arrays are calculated; and
Flow 5, the 8 hash values finally obtained through calculation are used as the second digest information of the received data and are output.

Step 402, the second terminal verifies validity of the received data according to a comparison result of the first digest information and the second digest information.

In some embodiments, when the first digest information and the second digest information are the same, the second terminal determines the received data to be valid; or
when the first digest information is different from the second digest information, the second terminal determines the received data to be invalid.

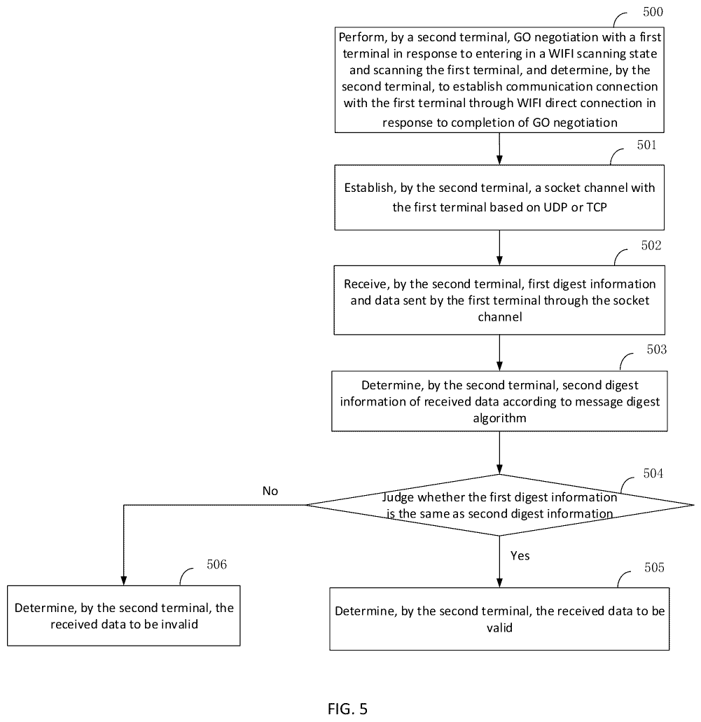

As shown in FIG. 5, the embodiment further provides a specific implementation flow of the cross-device data transmission method, shown as follows:
Step 500, the second terminal performs GO negotiation with the first terminal in response to entering in the WIFI scanning state and scanning the first terminal; and the second terminal determines to establish the communication connection with the first terminal through WIFI connection in response to completion of GO negotiation;
Step 501, the first terminal and the second terminal establish a socket channel based on the UDP or TCP;
Step 502, the second terminal receives the first digest information and the data sent by the first terminal through the socket channel;
Step 503, the second terminal determines the second digest information of the received data according to the message digest algorithm;
Step 504, it is judged whether the first digest information and the second digest information are the same, if yes, step 505 is executed, and otherwise, step 506 is executed; and
Step 505, the second terminal determines the received data to be valid; or
Step 506, the second terminal determines the received data to be invalid.

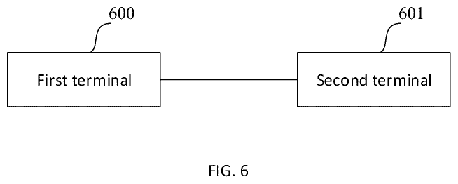

Based on the same inventive concept, as shown in FIG. 6, an embodiment further provides a cross-device data transmission system, including a first terminal 600 and a second terminal 601. The first terminal 600 in the embodiment includes but is not limited to a user terminal, and the second terminal 601 includes but is not limited to a smart meeting terminal; or, the first terminal 600 in the embodiment includes but is not limited to a smart meeting terminal, and the second terminal 601 includes but is not limited to a user terminal.

The user terminal includes but is not limited to: a mobile phone, a tablet computer, a notebook computer or other portable user terminals. The smart meeting terminal includes a meeting terminal, a conference all-in-one machine, etc.

The first terminal 600 is configured to obtain data to be transmitted, determine first digest information of the data to be transmitted, and send to the second terminal 601 the first digest information and the data to be transmitted, wherein the first digest information represents fixed-length encrypted information related to the data to be transmitted.

The second terminal 601 is configured to receive the first digest information and data sent by the first terminal 600, determine second digest information of the received data, and verify validity of the received data according to a comparison result of the first digest information and the second digest information.

In some embodiments, the first terminal 600 determines the first digest information of the data to be transmitted according to a message digest algorithm; and the second terminal 601 determines the second digest information of the received data according to the message digest algorithm.

The message digest algorithm used by the first terminal 600 and that used by the second terminal 601 are the same.

The message digest algorithm in the embodiment is an algorithm that produces a pseudo-random output of a fixed length by kneading and summing inputs of arbitrary length. In some embodiments, the message digest algorithm in the embodiment includes but is not limited to at least one of a message digest, a secure hash algorithm, or a message authentication code.

To take the secure hash algorithm SHA-256 as an example, a flow of calculating the first digest information of the data to be transmitted is as follows:
Flow 11, the data to be transmitted is read, the data is grouped by 64 bytes (512 digits), and a plurality of arrays are obtained;
Flow 12, the last array is analyzed, padding is performed according to requirements, and the last 8 bytes are padded as a data length of the data to be transmitted;
Flow 13, 8 hash values and the constant Kₜ are initialized; Flow 14, 64-byte arrays are loop input, and the hash values are calculated; wherein
for the first time, the first array, the initialized 8 32-digit hash values and the constant Kₜ are input, the 8 hash values output for the first time are obtained through calculation, the 8 hash values output for the first time are used as input for the second time, the second array and the constant Kₜ are input for the second time to obtain the 8 hash values output for the second time through further calculation, the 8 hash values output for the second time are used as input for the third time, and so on until all the arrays are calculated; and
Flow 15, the 8 hash values finally obtained through calculation are used as the first digest information of the data to be transmitted and are output.

To take the secure hash algorithm SHA-256 as an example, a flow of calculating the second digest information of the received data is as follows:
Flow 21, the received data is read, the data is grouped by 64 bytes (512 digits), and a plurality of arrays are obtained;
Flow 22, the last array is analyzed, padding is performed according to requirements, and the last 8 bytes are padded as a data length of the received data;
Flow 23, 8 hash values and the constant Kₜ are initialized;
Flow 24, 64-byte arrays are loop input, and the hash values are calculated; wherein for the first time, the first array, the initialized 8 32-digit hash values and the constant Kₜ are input, the 8 hash values output for the first time are obtained through calculation, the 8 hash values output for the first time are used as input for the second time, the second array and the constant Kₜ are input for the second time to obtain the 8 hash values output for the second time through further calculation, the 8 hash values output for the second time are used as input for the third time, and so on until all the arrays are calculated; and
Flow 25, the 8 hash values finally obtained through calculation are used as the second digest information of the received data and are output.

In some embodiments, the first terminal 600 and the second terminal 601 establish communication connection through a WIFI connection mode.

Before the first terminal 600 in the embodiment sends the data and the first digest information, the first terminal 600 needs to first establish communication connection with the second terminal 601. Normally, the communication connection may be established through Bluetooth or Wi-Fi for data transmission. Because Wi-Fi is wider in bandwidth, compared to Bluetooth, a file may be transmitted at a higher speed by using Wi-Fi. In some embodiments, the embodiment provides a mode for establishing the communication connection as follows:
the first terminal 600 establishes the communication connection with the second terminal 601 through a WIFI connection mode. In implementation, after the first terminal 600 establishes the communication connection with the second terminal 601 through WIFI connection, the first terminal 600 may send the first digest information and the data to be transmitted to the second terminal 601 through a WIFI mode, and exchange of data and messages may be performed through the WIFI mode.

In some embodiments, a process of the first terminal 600 and the second terminal 601 establishing WIFI connection is shown as follows:
the first terminal 600 performs group owner (GO) negotiation with the second terminal 601 in response to entering in a WIFI scanning state and scanning the second terminal 601; and
the first terminal 600 determines to establish the communication connection with the second terminal 601 in response to completion of GO negotiation.

In implementation, after the first terminal 600 and the second terminal 601 establish the communication connection, steps for transmitting the file usually include the following steps: step 1, a sending terminal discovers a receiving terminal; step 2, the sending terminal is connected to the receiving terminal; step 3, the sending terminal sends the file to the receiving terminal; and step 4, file sending is completed, and the sending terminal is disconnected from the receiving terminal. The first terminal 600 is the sending terminal and the second terminal 601 is the receiving terminal; or, the first terminal 600 is the receiving terminal and the second terminal 601 is the sending terminal, which is not overly limited in the embodiment.

The first terminal 600 and the second terminal 601 in the embodiment discover each other and establish the communication connection through WIFI connection. In implementation, a process of discovering and establishing the communication connection is as follows: the first terminal 600 and the second terminal 601 turn on Wi-Fi, both enter a scanning stage, and send a probe request to search all devices around; and then the first terminal 600 and the second terminal 601 alternatively enter a listening and a searching stage, and when a device sending a probe response exists, the device can be discovered. For example, when the second terminal 601 sends the probe response, the second terminal 601 may be discovered by the first terminal 600, and after the first terminal 600 or the second terminal 600 discovers a device, the discovered device may be shown for a user to choose. When the user chooses a device to be connected, for example, the user chooses on the first terminal 600 to connect to the second terminal 601, the first terminal 600 and the second terminal 601 start group owner (GO) negotiation. GO negotiation includes three types of frames, which are a GO request, a GO response and a GO confirmation. Between the two terminals performing GO negotiation, one of the terminals plays a role of a Wi-Fi direct group owner (GO), and the other terminal plays a role of a group client (GC). Optionally, the first terminal 600 is the GO and the second terminal 601 is the GC; or, the first terminal 600 is the GC and the second terminal 601 is the GO, which is not overly limited in the embodiment. After the first terminal 600 and the second terminal 601 perform GO negotiation, the two terminals establish the communication connection.

In some embodiments, to facilitate the user's operation, a prompt interface is further displayed on the first terminal 600 or the second terminal 601. The prompt interface includes reminder information such as discovery of the device, inputting of a verification code, and successful connection.

In some embodiments, before sending the data, the first terminal 600 may first send the first digest information to the second terminal 601, and then send the data. After receiving the data, the second terminal 600 uses the same message digest algorithm as used by the first terminal 600 to calculate second digest information of the received data, and compares the first digest information and the second digest information. If the two are the same, the data transmitted is normal and valid, or if the two are different, the data transmitted is incomplete or tampered, and is invalid.

In some embodiments, before sending the first digest information and the data to be transmitted to the second terminal 601, the first terminal 600 needs to establish a channel for data transmission with the second terminal 601, so as to perform transmission of data and files through an established socket channel. In implementation, the first terminal 600 and the second terminal 601 establish the socket channel based on a user datagram protocol (UDP) or a transmission control protocol (TCP); and the first terminal 600 sends to the second terminal 601 the first digest information and the data to be transmitted through the socket channel.

For the first terminal 600 and the second terminal 601 to establish the socket channel based on the UDP or TCP, a specific data frame format in a data transmission process is described above, and repetitions will not be made here.

In some embodiments, when the first terminal 600 fails to receive a response frame from the second terminal 601, the first terminal 600 may stop sending the data, display a sending failure and send a data frame on interrupted data transmission. When the second terminal 601 receives the data overtime, the second terminal 601 may also send a data frame on interrupted data transmission and stop a data transmission process.

In some embodiments, when the first digest information and the second digest information are the same, the second terminal 601 determines the received data to be valid, that is, the second terminal 601 determines the received data to be normal; or when the first digest information is different from the second digest information, the second terminal 601 determines the received data to be invalid, that is, the second terminal 601 determines the received data to be tampered or lost, and to be incomplete. The data may be tampered on purpose and be unsafe.

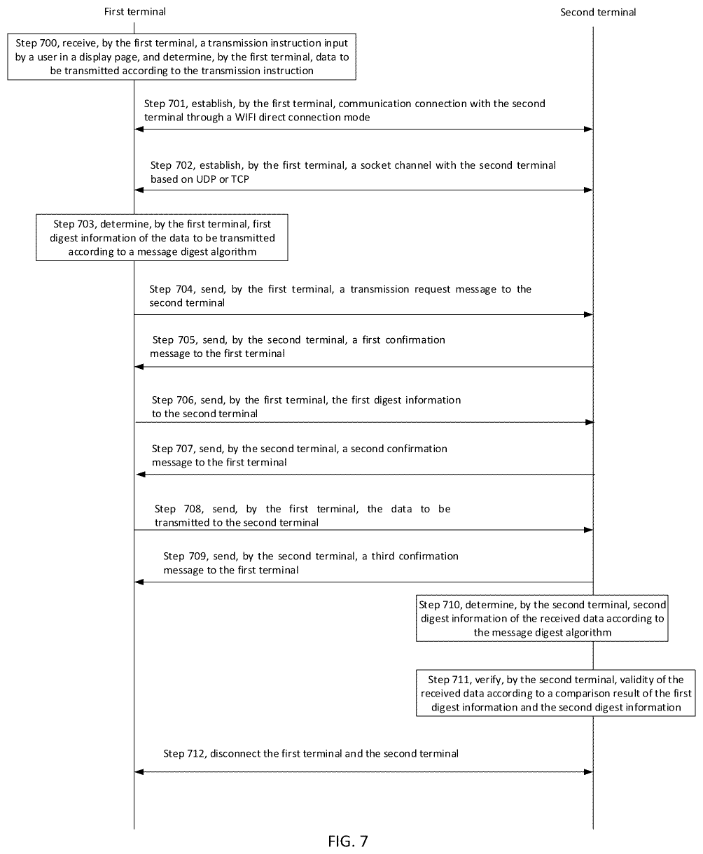

As shown in FIG. 7, an interaction process between the first terminal and the second terminal in the system is shown as follows:
Step 700, the first terminal receives a transmission instruction input by a user in a display page, and determines the data to be transmitted according to the transmission instruction;
Step 701, the first terminal and the second terminal establish the communication connection through the WIFI connection mode;
Step 702, the first terminal and the second terminal establish the socket channel based on the UDP or TCP;
Step 703, the first terminal determines the first digest information of the data to be transmitted according to the message digest algorithm;
Step 704, the first terminal sends a transmission request message to the second terminal;
Step 705, the second terminal sends a first confirmation message to the first terminal;
Step 706, the first terminal sends the first digest information to the second terminal;
Step 707, the second terminal sends a second confirmation message to the first terminal;
Step 708, the first terminal sends the data to be transmitted to the second terminal;
Step 709, the second terminal sends a third confirmation message to the first terminal;
Step 710, the second terminal determines the second digest information of the received data according to the message digest algorithm;
Step 711, the second terminal verifies the validity of the received data according to the comparison result of the first digest information and the second digest information; and
Step 712, the first terminal and the second terminal are disconnected.

In some embodiments, the embodiment may also encrypt the entire data to be transmitted before transmitting it, and then the second terminal decrypts the data after receiving it. A symmetric or asymmetric encryption algorithm may be used. The asymmetric encryption algorithm is more secure, but due to the complexity of the algorithm, a transmission speed may be lower. Security ranking: asymmetric encryption>message digest>symmetric encryption; and transmission speed: message digest>symmetric encryption >asymmetric encryption.

In some embodiments, the first terminal and the second terminal in the embodiment have built-in WiFi modules, and a transmission channel may be established via WiFi to realize file transmission. The first terminal in the embodiment may act as a sending terminal of the data and the second terminal as a receiving terminal of the data, or, the first terminal may act as the receiving terminal of the data and the second terminal as the sending terminal of the data, and the first terminal and the second terminal may realize mutual transmission of data, files and other information.

Embodiment 2. Based on the same inventive concept, an embodiment of the present disclosure further provides a terminal. Because the terminal is the terminal in the method in the embodiment of the present disclosure and a problem solving principle of the terminal is similar to that of the method, for implementation of the terminal, reference may be made to implementation of the method, and repetitions will not be made here.

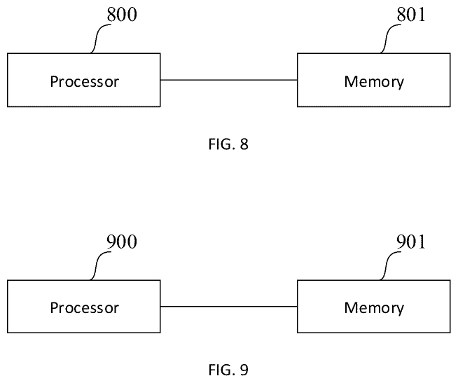

As shown in FIG. 8, the terminal includes a processor 800 and a memory 801. The memory is configured to store a program executable by the processor 800, and the processor 800 is configured to read the program in the memory 801 and execute the following steps:
data to be transmitted is obtained;
first digest information of the data to be transmitted is determined, wherein the first digest information represents fixed-length encrypted information related to the data to be transmitted; and
the first digest information and the data to be transmitted are sent to a second terminal, so that the second terminal verifies validity of received data according to the first digest information.

As an optional implementation, the processor 800 is specifically configured to execute:
determining the first digest information of the data to be transmitted according to a message digest algorithm.

As an optional implementation, before the sending to a second terminal the first digest information and the data to be transmitted, the processor 800 is specifically further configured to execute:
establishing communication connection with a second terminal through a WIFI connection mode.

As an optional implementation, the processor 800 is specifically configured to execute:
performing GO negotiation with the second terminal in response to entering in a WIFI scanning state and scanning the second terminal; and
determining to establish the communication connection with the second terminal in response to completion of GO negotiation.

As an optional implementation, the processor 800 is specifically configured to execute:
establishing a socket channel with the second terminal based on UDP or TCP; and
sending to the second terminal the first digest information and the data to be transmitted through the socket channel.

As an optional implementation, the processor 800 is specifically configured to execute:
receiving a transmission instruction input by a user in a display page, and determining the data to be transmitted according to the transmission instruction.

Embodiment 3. Based on the same inventive concept, an embodiment of the present disclosure further provides a terminal. Because the terminal is the terminal in the method in the embodiment of the present disclosure and a problem solving principle of the terminal is similar to that of the method, for implementation of the terminal, reference may be made to implementation of the method, and repetitions will not be made here.

As shown in FIG. 9, the terminal includes a processor 900 and a memory 901. The memory 901 is configured to store a program executable by the processor 900, and the processor 900 is configured to read the program in the memory 901 and execute the following steps:
first digest information and data sent by a first terminal are received;
second digest information of the received data is determined; and
validity of the received data is verified according to a comparison result of the first digest information and the second digest information.

As an optional implementation, the processor 900 is specifically configured to execute:
determining the second digest information of the received data according to a message digest algorithm.

As an optional implementation, before the receiving first digest information and data sent by a first terminal, the processor 900 is specifically further configured to execute:
establishing communication connection with the first terminal through a WIFI connection mode.

As an optional implementation, the processor 900 is specifically configured to execute:
performing GO negotiation with the first terminal in response to entering in a WIFI scanning state and scanning the first terminal; and
determining to establish the communication connection with the first terminal in response to completion of GO negotiation.

As an optional implementation, the processor 900 is specifically configured to execute:
establishing a socket channel with the first terminal based on UDP or TCP; and
receiving the first digest information and the data through the socket channel.

As an optional implementation, the processor 900 is specifically configured to execute:
determining the received data to be valid in response to determining that the first digest information is the same as the second digest information; or
determining the received data to be invalid in response to determining that the first digest information is different from the second digest information.

### Embodiment 4. Based on the same inventive concept, an embodiment of the

present disclosure further provides a first cross-device data transmission apparatus. Because the apparatus is the apparatus in the method in the embodiment of the present disclosure and a problem solving principle of the apparatus is similar to that of the method, for implementation of the apparatus, reference may be made to implementation of the method, and repetitions will not be made here.

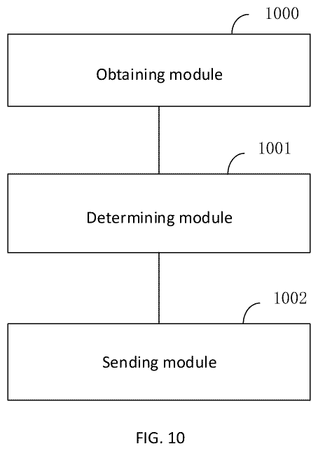

As shown in FIG. 10, the apparatus includes:
an obtaining module 1000, configured to obtain data to be transmitted;
a determining module 1001, configured to determine first digest information of the data to be transmitted, wherein the first digest information represents fixed-length encrypted information related to the data to be transmitted; and
a sending module 1002, configured to send to a second terminal the first digest information and the data to be transmitted, so that the second terminal verifies validity of received data according to the first digest information.

As an optional implementation, the determining module 1001 is specifically configured to:
determine the first digest information of the data to be transmitted according to a message digest algorithm.

As an optional implementation, before the sending to a second terminal the first digest information and the data to be transmitted, the apparatus further includes a connecting module configured to:
establish communication connection with a second terminal through a WIFI connection mode.

As an optional implementation, the connecting module is specifically configured to:
perform GO negotiation with the second terminal in response to entering in a WIFI scanning state and scanning the second terminal; and
determine to establish the communication connection with the second terminal in response to completion of GO negotiation.

As an optional implementation, the sending module 1002 is specifically configured to:
establish a socket channel with the second terminal based on UDP or TCP; and
send to the second terminal the first digest information and the data to be transmitted through the socket channel.

As an optional implementation, the obtaining module 1000 is specifically configured to:
receive a transmission instruction input by a user in a display page, and determine the data to be transmitted according to the transmission instruction.

Embodiment 5. Based on the same inventive concept, an embodiment of the present disclosure further provides a second cross-device data transmission apparatus. Because the apparatus is the apparatus in the method in the embodiment of the present disclosure and a problem solving principle of the apparatus is similar to that of the method, for implementation of the apparatus, reference may be made to implementation of the method, and repetitions will not be made here.

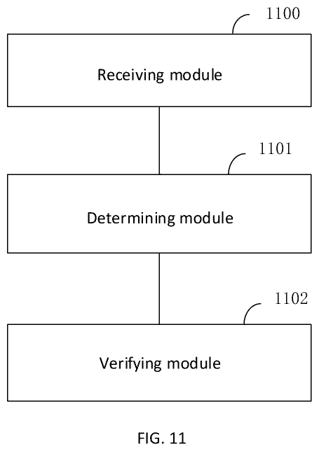

As shown in FIG. 11, the apparatus includes:
a receiving module 1100, configured to receive first digest information and data sent by a first terminal;
a determining module 1101, configured to determine second digest information of the received data; and
a verifying module 1102, configured to verify validity of the received data according to a comparison result of the first digest information and the second digest information.

As an optional implementation, the receiving module 1100 is specifically configured to:
determine the second digest information of the received data according to a message digest algorithm.

As an optional implementation, before the receiving first digest information and data sent by a first terminal, the apparatus further includes a connecting module configured to: establish communication connection with the first terminal through a WIFI connection mode.

As an optional implementation, the connecting module is specifically configured to:
perform GO negotiation with the first terminal in response to entering in a WIFI scanning state and scanning the first terminal; and
determine to establish the communication connection with the first terminal in response to completion of GO negotiation.

As an optional implementation, the receiving module 1100 is specifically configured to:
establish a socket channel with the first terminal based on UDP or TCP; and
receive the first digest information and the data through the socket channel.

As an optional implementation, the verifying module 1102 is specifically configured to:
determine the received data to be valid in response to determining that the first digest information is the same as the second digest information; or
determine the received data to be invalid in response to determining that the first digest information is different from the second digest information.

Based on the same inventive concept, an embodiment of the present disclosure further provides a non-transient computer storage medium. The storage medium stores a computer-executable instruction, and the computer-executable instruction, when executed by a processor, implements the following steps:
data to be transmitted is obtained;
first digest information of the data to be transmitted is determined, wherein the first digest information represents fixed-length encrypted information related to the data to be transmitted; and
the first digest information and the data to be transmitted are sent to a second terminal, so that the second terminal verifies validity of received data according to the first digest information.

Based on the same inventive concept, an embodiment of the present disclosure further provides a non-transient computer storage medium. The storage medium stores a computer-executable instruction, and the computer-executable instruction, when executed by a processor, implements the following steps:
first digest information and data sent by a first terminal are received;
second digest information of the received data is determined; and
validity of the received data is verified according to a comparison result of the first digest information and the second digest information.

Those of skill in the art should understand that the embodiments of the present disclosure may be provided as a method, a system, or a computer program product. Therefore, the present disclosure may adopt the form of a complete hardware embodiment, a complete software embodiment, or an embodiment combining software and hardware. Moreover, the present disclosure may take the form of a computer program product implemented on one or more computer-usable storage media (including but not limited to disk storage, CD-ROM, optical storage, etc.) containing computer-usable program codes.

The present disclosure is described with reference to flowcharts and/or block diagrams of methods, devices (systems), and computer program products according to the present disclosure. It should be understood that each process and/or block in the flowcharts and/or block diagrams, and the combination of processes and/or blocks in the flowcharts and/or block diagrams can be realized by computer program instructions. These computer program instructions can be provided to a processor of a general-purpose computer, a special-purpose computer, an embedded processor, or other programmable data processing devices to generate a machine, so that the instructions executed by the processor of the computer or other programmable data processing devices generate an apparatus that realizes the functions specified in one process or multiple processes in the flowcharts and/or one block or multiple blocks in the block diagrams.

These computer program instructions may also be stored in a computer-readable memory that can direct the computer or other programmable data processing devices to work in a specific manner, so that the instructions stored in the computer-readable memory produce an article of manufacture including an instruction apparatus that realizes the functions specified in one process or multiple processes in the flowcharts and/or one block or multiple blocks in the block diagrams.

These computer program instructions may also be loaded on the computer or other programmable data processing devices, so that a series of operation steps are executed on the computer or other programmable devices to produce computer-implemented processing, so that the instructions executed on the computer or other programmable data processing devices provide steps for realizing the functions specified in one process or multiple processes in the flowcharts and/or one block or multiple blocks in the block diagrams.

Apparently, those of skill in the art can make various changes and modifications to the present disclosure without departing from the spirit and scope of the present disclosure. In this way, if these changes and modifications of the present disclosure fall within the scope of the claims of the present disclosure and their equivalent technologies, the present disclosure also intends to include these changes and modifications.

1. A data transmission method, comprising:
obtaining, by a first terminal, data to be transmitted;
determining, by the first terminal, a first digest information of the data to be transmitted, wherein the first digest information represents fixed-length encrypted information related to the data to be transmitted; and
sending, by the first terminal, the first digest information and the data to be transmitted to a second terminal, so that the second terminal verifies validity of received data according to the first digest information.

2. The method according to claim 1, wherein the determining, by the first terminal, first digest information of the data to be transmitted, comprises:
determining, by the first terminal, the first digest information of the data to be transmitted according to a message digest algorithm.

3. The method according to claim 1, before the sending, by the first terminal, to a second terminal the first digest information and the data to be transmitted, further comprising:
establishing, by the first terminal, communication connection with the second terminal through a WIFI connection mode.

4. The method according to claim 3, wherein the establishing, by the first terminal, communication connection with the second terminal through a WIFI connection mode, comprises:
performing, by the first terminal, a GO negotiation with the second terminal in response to the first terminal entering in a WIFI scanning state and scanning the second terminal; and
determining, by the first terminal, to establish the communication connection with the second terminal in response to completion of GO negotiation.

5. The method according to claim 1, wherein the sending, by the first terminal, to a second terminal the first digest information and the data to be transmitted, comprises:
establishing, by the first terminal, a socket channel with the second terminal based on UDP or TCP; and
sending, by the first terminal, the first digest information and the data to be transmitted to the second terminal through the socket channel.

6. The method according to claim 1, wherein the obtaining, by a first terminal, data to be transmitted comprises:
receiving, by the first terminal, a transmission instruction input by a user in a display page, and determining, by the first terminal, the data to be transmitted according to the transmission instruction.

7. A data transmission method, comprising
receiving, by a second terminal, a first digest information and data sent by a first terminal;
determining, by the second terminal, a second digest information of received data; and
verifying, by the second terminal, validity of the received data according to a comparison result of the first digest information and the second digest information.

8. The method according to claim 7, wherein the determining, by the second terminal, a second digest information of the received data comprises:
determining, by the second terminal, the second digest information of the received data according to a message digest algorithm.

9. The method according to claim 7, wherein before the receiving, by a second terminal, a first digest information and data sent by a first terminal, further comprising:
establishing, by the second terminal, communication connection with the first terminal through a WIFI connection mode.

10. The method according to claim 9, wherein the establishing, by the second terminal, communication connection with the first terminal through a WIFI connection mode, comprises:
performing, by the second terminal, a GO negotiation with the first terminal in response to the second terminal entering in a WIFI scanning state and scanning the first terminal; and
determining, by the second terminal, to establish the communication connection with the first terminal in response to completion of GO negotiation.

11. The method according to claim 7, wherein the receiving, by a second terminal, a first digest information and data sent by a first terminal, comprises:
establishing, by the second terminal, a socket channel with the first terminal based on UDP or TCP; and
receiving, by the second terminal, the first digest information and the data through the socket channel.

12. The method according to claim 7, wherein the verifying, by the second terminal, validity of the received data according to a comparison result of the first digest information and the second digest information, comprises:
determining, by the second terminal, the received data to be valid in response to determining that the first digest information is the same as the second digest information; or
determining, by the second terminal, the received data to be invalid in response to determining that the first digest information is different from the second digest information.

13. A data transmission system, comprising a first terminal and a second terminal, wherein
the first terminal is configured to obtain data to be transmitted, determine a first digest information of the data to be transmitted, and send the first digest information and the data to be transmitted to a second terminal, wherein the first digest information represents fixed-length encrypted information related to the data to be transmitted; and
the second terminal is configured to receive the first digest information and data sent by the first terminal, determine a second digest information of the received data, and verify validity of the received data according to a comparison result of the first digest information and the second digest information.

14. The system according to claim 13, wherein
the first terminal determines the first digest information of the data to be transmitted according to a message digest algorithm; and
the second terminal determines the second digest information of received data according to the message digest algorithm.

15. The system according to claim 13, further comprising:
establishing, by the first terminal, communication connection with the second terminal through a WIFI connection mode.

16. The system according to claim 13, wherein the second terminal verifies validity of the received data according to a comparison result of the first digest information and the second digest information, by:
determining the received data to be valid in response to determining that the first digest information is the same as the second digest information; or
determining the received data to be invalid in response to determining that the first digest information is different from the second digest information.

17. A terminal, comprising a processor and a memory, wherein the memory is configured to store a program executable by the processor, and the processor is configured to read the program in the memory and execute steps of the method according to claim 1.

18. A terminal, comprising a processor and a memory, wherein the memory is configured to store a program executable by the processor, and the processor is configured to read the program in the memory and execute steps of the method according to claim 7.

19. A non-transient computer storage medium, wherein the storage medium stores a computer-executable instruction, and the computer-executable instruction, in response to being executed by a processor, implements steps of the method according to claim 1.

20. A non-transient computer storage medium, wherein the storage medium stores a computer-executable instruction, and the computer-executable instruction, in response to being executed by a processor, implements steps of the method according to claim 7.
